(19) United States
(12) Patent Application Publication
(10) Pub. No.: US 2022/0136591 A1
(43) Pub. Date: May 5, 2022

(54) LINEAR ACTUATOR

(71) Applicant: NTN Corporation, Osaka (JP)

(72) Inventors: Ryousuke OBARA, Shizuoka (JP); Akio KATO, Shizuoka (JP)

(21) Appl. No.: 17/433,749

(22) PCT Filed: Feb. 20, 2020
(86) PCT No.: PCT/JP2020/006805

§ 371 Date: Aug. 25, 2021

(30) Foreign Application Priority Data
Mar. 5, 2019 (JP) 2019-039542

(51) Int. Cl. F16H 25/20; F16H 25/24

(52) U.S. Cl. CPC F16H 25/2021; F16H 2025/2463; F16H 25/2454

(57) ABSTRACT

A linear actuator 1 includes a motor 2, a rotary unit (a screw shaft 5) to be rotationally driven by the motor 2, and a linear motion unit 6 to be screwed with the screw shaft 5 and to linearly move in an axial direction in accordance with rotation of the screw shaft 5. The linear motion unit 6 includes a linear motion unit main body 7 (a nut 10 and a spring case 11), an output member 8 provided to be relatively movable in the axial direction with respect to the linear motion unit main body 7, and configured to abut an operation target P, and a spring 9 disposed between the linear motion unit main body 7 and the output member 8 in the axial direction.

### TECHNICAL FIELD

The present invention relates to a linear actuator that converts rotary motion of a motor into linear motion and that outputs the linear motion.

### BACKGROUND ART

As a linear actuator, there is a well-known linear actuator including a motion conversion mechanism (a screw mechanism) in which a motor rotates one of a screw shaft and a nut that are screwed with each other, so as to linearly move the other. In such a linear actuator, when the screw shaft (or the nut) is rotationally driven by the motor and the nut (or the screw shaft) is moved in the axial direction to press an output member that is attached thereto against an operation target, a screw groove of the screw shaft and a screw groove of the nut may get stuck with each other. In this case, even when the screw shaft (or the nut) is made to rotate in the reverse direction by the motor, the screw shaft (or the nut) does not rotate in the reverse direction due to being stuck of a screwed portion.

Hence, there is a possibility that the output member cannot be separated from the operation target.

For example, Patent Literature 1 to be listed below discloses a linear actuator in which a nut is rotated to linearly move a screw shaft.

A nut-side locking piece part provided on the nut and a screw-shaft-side stopper part provided on the screw shaft are engaged with each other in a circumferential direction, so that the rotation of the nut is restricted at a predetermined position. In such a linear actuator, the stress generated when the nut-side locking piece part and the screw-shaft-side stopper part abut each other in the circumferential direction is absorbed by deformation of cushion rubber, so that damage of a gear caused by the above-described stress is prevented.

### CITATIONS LIST

### Patent Literature

Patent Literature 1: JP 2014-92223 A

### SUMMARY OF INVENTION

### Technical Problems

In the linear actuator as described above, however, a plurality of pieces of cushion rubber are provided at equal intervals in the circumferential direction between the gear and the nut.

Hence, the number of component parts increases, and the structure becomes complicated.

Therefore, an object of the present invention is to prevent a screwed portion of a rotary unit and a linear motion unit (for example, a screw shaft and a nut) of a linear actuator from getting stuck, with a small number of component parts.

### Solutions to Problems

In order to solve the above problems, the present invention provides a linear actuator including: a motor; a rotary unit to be rotationally driven by the motor; and a linear motion unit including a screw groove to be screwed with a screw groove provided on the rotary unit, and configured to linearly move in an axial direction in accordance with rotation of the rotary unit, wherein the linear motion unit includes: a linear motion unit main body including the screw groove; an output member provided to be relatively movable in an axial direction with respect to the linear motion unit main body, and configured to abut an operation target; and a spring disposed between the linear motion unit main body and the output member in the axial direction.

As described above, in the linear actuator according to the present invention, the linear motion unit main body that linearly moves in accordance with the rotation of the rotary unit and the output member that abuts the operation target are relatively movable in the axial direction, and the spring is disposed between them. In this case, when the rotary unit is rotationally driven in the normal direction by the motor to linearly move the linear motion unit and to cause the output member to abut the operation target, the linear motion unit main body is continuously moving linearly while compressing the spring in a state where the output member stops at the position. In this manner, while the linear motion unit main body and the output member are being floating-supported in the axial direction by the elastic force of the spring, the output member is made to abut the operation target, so that only the elastic force of the spring is applied to the screwed portion of the rotary unit and the linear motion unit.

Therefore, the force in the axial direction applied to the screwed portion is reduced, and it is possible to prevent the screwed portion from getting stuck. This mechanism is configured with only the provision of the spring between the linear motion unit main body and the output member.

Therefore, the number of component parts is reduced as compared with a conventional linear actuator in which a plurality of pieces of cushion rubber are provided at equal intervals in the circumferential direction.

The above-described linear actuator can comprise a rotation restriction unit configured to restrict the rotation in a normal direction of the rotary unit at a predetermined position. The normal direction is a direction of pressing the output member against the operation target. Before the rotation restriction unit restricts the rotation in the normal direction of the rotary unit, when the linear motion unit main body and the output member directly abut each other in the axial direction without an intervention of the spring, a large load is applied to the screwed portion of the linear motion unit and the rotary unit.

Hence, the screwed portion may get stuck. Therefore, a gap in a direction of compressing the spring is preferably defined between the linear motion unit main body and the output member, in a state where the rotation restriction unit restricts the rotation in the normal direction of the rotary unit.

In a case where the screwed portion of the rotary unit and the linear motion unit is a sliding screw in which the screw grooves of both members are directly meshed with each other, the screwed portion is likely to get stuck.

Therefore, it is particularly effective to adopt the above-described structure.

In the above-described linear actuator, the force pressing the output member against the operation target depends on the elastic force of the spring. Therefore, the spring is disposed beforehand in a compressed state between the linear motion unit main body and the output member in the axial direction, so that the force of pressing the output member against the operation target can be increased.

The present invention is applicable to, for example, a coaxial type of a linear actuator in which the motor and the rotary unit are coaxially disposed, or a parallel axial type of an electric actuator in which a central axis of the motor and a central axis of the rotary unit are disposed to be separated in parallel with each other.

Further, the present invention is also applicable to an axial rotation type of a linear actuator in which the rotary unit includes a screw shaft, and the linear motion unit includes a nut to be screwed with the screw shaft, and is also applicable to a nut rotation type of a linear actuator in which the rotary unit includes a nut, and the linear motion unit includes a screw shaft to be screwed with the nut.

### Advantageous Effects of Invention

As described above, according to the linear actuator of the present invention, with a small number of component parts, it is possible to prevent the screwed portion of the rotary unit and the linear motion unit (for example, the screw shaft and the nut) that are screwed with each other from getting stuck.

### BRIEF DESCRIPTION OF DRAWINGS

FIG. 1 is a cross-sectional view of a linear actuator according to an embodiment of the present invention.

FIG. 2 is a cross-sectional view taken along line II-II of FIG. 1.

FIG. 3 is a cross-sectional view taken along line of FIG. 1.

FIG. 4 is a cross-sectional view illustrating a state in which an output member of the linear actuator is made to abut an operation target.

FIG. 5 is a cross-sectional view illustrating a state in which a linear motion unit main body of the linear actuator is moved to a front end position.

FIG. 6 is a graph illustrating a relationship between a stroke amount of the linear motion unit main body of the linear actuator and a load applied to a motor.

FIG. 7 is a cross-sectional view of a linear actuator according to another embodiment.

FIG. 8 is a cross-sectional view illustrating a state in which the linear motion unit main body of the linear actuator of FIG. 7 is moved to a rear end position.

FIG. 9 is a cross-sectional view (a cross-sectional view taken along line IX-IX of FIG. 10) of a linear actuator according to still another embodiment.

FIG. 10 is a cross-sectional view taken along line X-X of FIG. 9.

FIG. 11 is a cross-sectional view taken along line XI-XI of FIG. 10.

FIG. 12 is a cross-sectional view taken along line XII-XII of FIG. 10.

FIG. 13 is a cross-sectional view of a linear actuator according to further another embodiment.

### DESCRIPTION OF EMBODIMENTS

Hereinafter, embodiments of the present invention will be described with reference to the drawings.

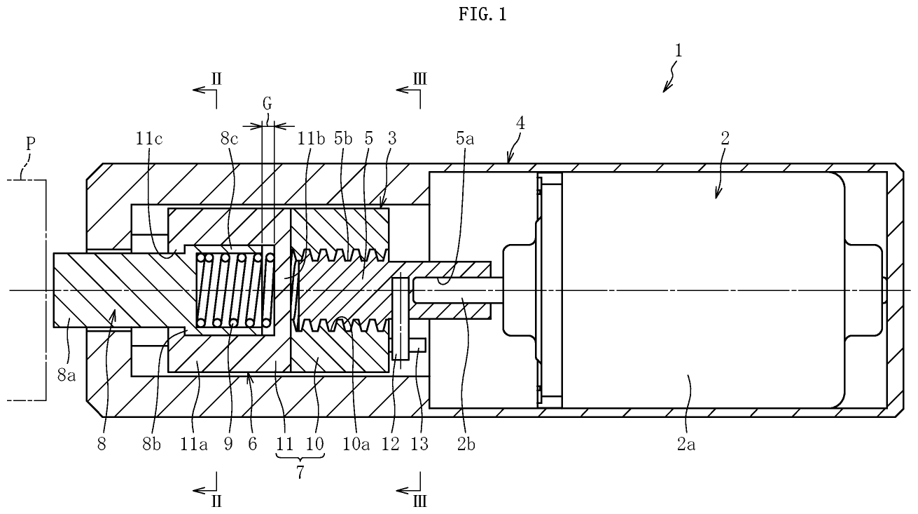

As illustrated in FIG. 1, a linear actuator 1 according to an embodiment of the present invention includes a motor 2, a screw mechanism 3 as a motion conversion mechanism that converts rotary motion of the motor 2 into linear motion, and a housing 4 that accommodates the motor 2 and the screw mechanism 3. Note that the housing 4 is illustrated as one component part in the illustrated example.

However, the housing is actually formed of a plurality of component parts in order to accommodate the motor 2 and the screw mechanism 3 inside the housing.

The motor 2 includes a motor main body 2a secured to an inner periphery of the housing 4, and a rotary shaft 2b that protrudes from the motor main body 2a. The motor main body 2a is connected with a power supply provided outside the housing 4 via wiring, not illustrated.

The screw mechanism 3 includes a screw shaft 5 as a rotary unit to be rotationally driven by the motor 2, and a linear motion unit 6 that linearly moves in an axial direction in accordance with the rotation of the rotary unit. Note that in the following description, an operation target P side (the left side in the drawing) is referred to as a front side, and a motor 2 side (the right side in the drawing) is referred to as a rear side, in the axial direction.

The screw shaft 5 is coupled with the rotary shaft 2b of the motor 2. For example, the rotary shaft 2b of the motor 2 is press-fit and secured to a bore 5a defined at a rear end of the screw shaft 5. A screw groove 5b is formed on an outer circumferential surface of the screw shaft 5. Note that an uneven shape of a spiral shape or a mesh shape may be provided on an outer circumferential surface of the rotary shaft 2b of the motor 2, and such an uneven shape may be made to bite into an inner peripheral surface of the bore 5a of the screw shaft 5. This configuration enables prevention of idling between the rotary shaft 2b of the motor 2 and the screw shaft 5.

The linear motion unit 6 includes a linear motion unit main body 7, an output member 8 provided to be relatively movable in the axial direction with respect to the linear motion unit main body 7, and a spring 9 disposed between the linear motion unit main body 7 and the output member 8 in the axial direction.

The linear motion unit main body 7 includes a nut 10 in which a screw groove 10a to be screwed with the screw groove 5b of the screw shaft 5 is formed on the inner peripheral surface, and a spring case 11 in which the spring 9 is accommodated on the inner periphery. In the present embodiment, a screwed portion of the screw mechanism 3 is configured with a sliding screw in which the screw groove 5b of the screw shaft 5 and the screw groove 10a of the nut 10 directly mesh each other. The nut 10 and the spring case 11 are secured to each other with bolts or the like. The spring case 11 includes a side part 11a having a cylindrical shape, a bottom part 11b that closes an opening at a rear end of the side part 11a, and a flange part 11c that protrudes on an inner diameter side from an opening at a front end of the side part 11a. Note that although the spring case 11 is illustrated as one component part in the illustrated example, but the spring case 11 is actually formed of a plurality of component parts in order to incorporate the output member 8 and the spring 9 into the spring case 11. For example, the spring case 11 is configured with a component part integrally including the side part 11a and the flange part 11c, and the bottom part 11b formed separately from such a component part.

These parts are secured by bolts or the like.

The output member 8 includes an output shaft part 8a to abut the operation target P, a flange part 8b that protrudes outward on an outer diameter side from a rear end of the output shaft part 8a, and a side part 8c having a cylindrical shape and extending rearward from an outer diameter end of the flange part 8b. The outer circumferential surface of the side part 8c of the output member 8 is fit with the inner peripheral surface of the side part 11a of the spring case 11. This configuration enhances the coaxial degree between the output member 8 and the spring case 11. The flange part 8b of the output member 8 abuts the flange part 11c of the spring case 11 from the rear side.

Accordingly, a frontward movement of the output member 8 with respect to the spring case 11 is restricted.

The spring 9 is disposed between the output member 8 and the linear motion unit main body 7 in the axial direction.

In the illustrated example, the spring 9 is disposed between the output shaft part 8a of the output member 8 and the bottom part 11b of the spring case 11 of the linear motion unit main body 7. A gap G in the axial direction is defined between the output member 8 and the linear motion unit main body 7, so that the output member 8 and the linear motion unit main body 7 are relatively movable in the axial direction in a direction in which the gap G decreases, while compressing the spring 9. In the present embodiment, the spring 9 is disposed beforehand in a compressed state between the output member 8 and the linear motion unit main body 7 (the spring case 11). This configuration constantly urges the output member 8 frontward with respect to the spring case 11, and constantly presses the flange part 8b of the output member 8 against the flange part 11c of the spring case 11.

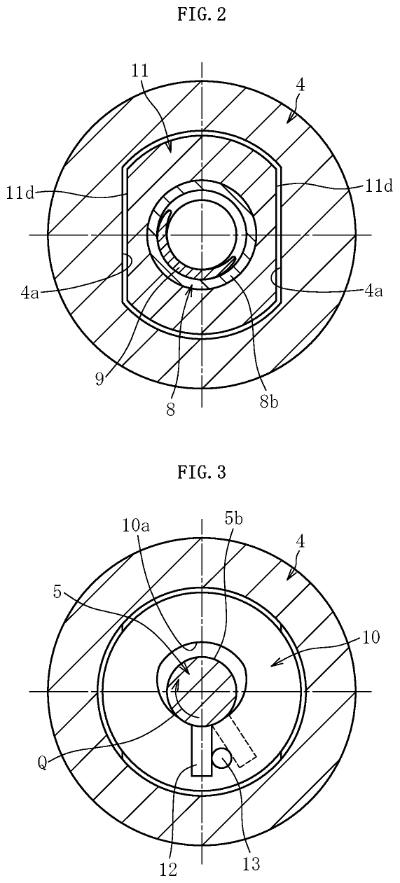

The linear motion unit main body 7 is allowed to move in the axial direction with respect to the housing 4, but is restricted from rotating with respect to the housing 4. In the present embodiment, as illustrated in FIG. 2, a pair of parallel flat surfaces 11d are provided on the outer circumferential surface of the spring case 11, and in addition, a pair of parallel flat surfaces 4a are provided on the inner peripheral surface of the housing 4, so that these surfaces are fit together. The flat surface 11d of the spring case 11 and the flat surface 4a of the housing 4 are engaged with each other in a rotational direction.

Accordingly, the rotation of the linear motion unit main body 7 including the spring case 11 with respect to the housing 4 is restricted.

The screw mechanism 3 is provided with a rotation restriction unit that restricts the rotation of the screw shaft 5 at a predetermined position. In the present embodiment, as illustrated in FIGS. 1 and 3, a screw-shaft-side locking part 12 that protrudes on an outer diameter side from the outer circumferential surface of the screw shaft 5, and a nut-side locking part 13 that protrudes rearward from an end surface of the nut 10 constitute the rotation restriction unit. FIGS. 1 and 3 illustrate a state in which the linear motion unit main body 7 is disposed at a rear end position.

From this state, the screw shaft 5 rotates in a normal direction (a direction of an arrow Q in FIG. 3), so that the linear motion unit main body 7 moves frontward. Then, as indicated by a dotted line in FIG. 3, the screw-shaft-side locking part 12 abuts the nut-side locking part 13.

Accordingly, the rotation of the screw shaft 5 in the normal direction is restricted, and the linear motion unit main body 7 stops at a front end position. Further, the screw shaft 5 rotates in a reverse direction (a direction opposite to the arrow Q), so that the linear motion unit main body 7 moves rearward. Then, as indicated by a solid line in FIG. 3, the screw-shaft-side locking part 12 abuts the nut-side locking part 13.

Accordingly, the rotation of the screw shaft 5 in the reverse direction is restricted, and the linear motion unit main body 7 stops at a rear end position. As described above, in the linear actuator 1 in the present embodiment, the screw shaft 5 is allowed to rotate by approximately one rotation (from the solid line position to the dotted line position of the screw-shaft-side locking part 12 in FIG. 3), and the linear motion unit main body 7 moves in the axial direction to correspond to the rotation.

Next, an operation of the linear actuator 1 will be described.

The motor 2 is driven to rotate the screw shaft 5 in the normal direction from a state where the linear motion unit main body 7 is disposed at the rear end position as illustrated in FIG. 1.

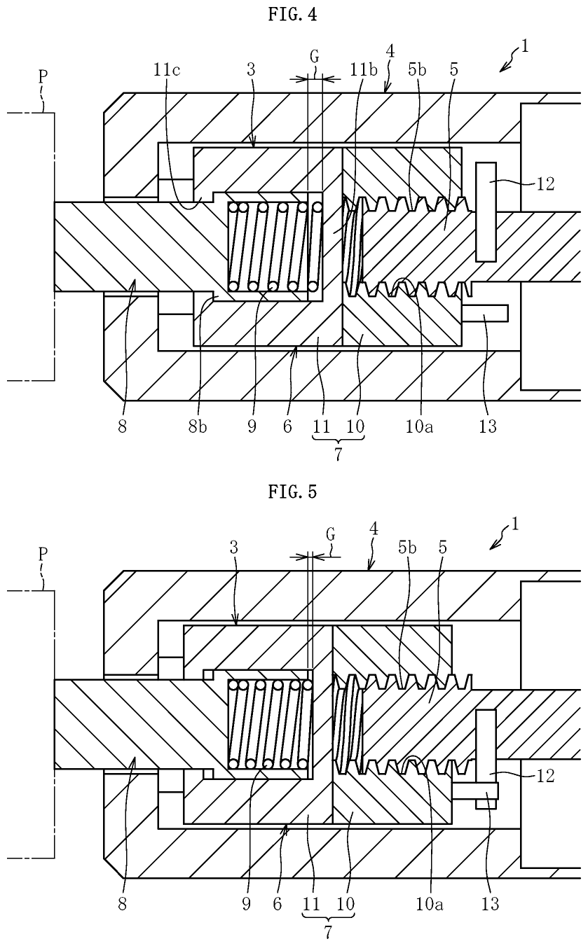

Then, the linear motion unit main body 7 (the nut 10 and the spring case 11) constituting the linear motion unit 6, the output member 8, and the spring 9 integrally move frontward. In this situation, the output member 8 is biased frontward by the spring 9 with respect to the linear motion unit main body 7, and is also floating-supported in a state of being movable rearward with respect to the linear motion unit main body 7. Then, when the output member 8 abuts the operation target P as illustrated in FIG. 4, the output member 8 stops at the position, whereas the linear motion unit main body 7 moves frontward while compressing the spring 9. In this situation, only elastic force of the spring 9 is applied to the screwed portion of the screw groove 5b of the screw shaft 5 and the screw groove 10a of the nut 10.

Therefore, the force in the axial direction applied to the screwed portion is reduced, and the screwed portion can be prevented from getting stuck.

Then, the screw-shaft-side locking part 12 abuts the nut-side locking part 13 (see the dotted line in FIG. 3).

Accordingly, the rotation of the screw shaft 5 in the normal direction is restricted, and the linear motion unit main body 7 is stopped (see FIG. 5). In this situation, the gap G in the axial direction remains between the output member 8 and the bottom part 11b of the spring case 11. That is, before the linear motion unit main body 7 abuts the output member 8 from the rear side, the screw-shaft-side locking part 12 abuts the nut-side locking part 13, restricts the rotation of the screw shaft 5, and stops the frontward movement of the linear motion unit main body 7. In this manner, while the linear motion unit main body 7 is linearly moving, the output member 8 is always floating-supported in a state of being relatively movable to a side of compressing the spring 9 with respect to the linear motion unit main body 7.

Therefore, it is possible to reliably prevent a situation in which a large load is applied to the screwed portion of the screw shaft 5 and the nut 10, and the screwed portion gets stuck.

Then, when the screw shaft 5 is rotationally driven by the motor 2 in the reverse direction from the state illustrated in FIG. 5, the linear motion unit main body 7 moves rearward, while the output member 8 remains in abutment with the operation target P. In this situation, the screwed portion of the screw groove 5b of the screw shaft 5 and the screw groove 10a of the nut 10 do not get stuck as described above.

Accordingly, the linear motion unit main body 7 including the nut 10 can be smoothly moved rearward by rotationally driving the motor 2 in the reverse direction. Then, as illustrated in FIG. 4, after the flange part 11c of the spring case 11 is engaged with the flange part 8b of the output member 8 from the front side, the linear motion unit main body 7 and the output member 8 integrally move rearward. Subsequently, the screw-shaft-side locking part 12 abuts the nut-side locking part 13 (see the solid line in FIG. 3).

Accordingly, the rotation of the screw shaft 5 in the reverse direction is restricted, and the linear motion unit main body 7 and the output member 8 stop at the rear end position (see FIG. 1).

As in the present embodiment, in a case where the screwed portion of the rotary unit and the linear motion unit of the screw mechanism 3 is configured with a sliding screw in which the screw groove 5b of the screw shaft 5 and the screw groove 10a of the nut 10 are directly meshed with each other, getting stuck is likely to occur due to friction between the screw grooves 5b and 10a.

Therefore, it is particularly effective to avoid getting stuck via the spring 9 as described above. Note that even in a case where the screwed portion of the rotary unit and the linear motion unit of the screw mechanism 3 is a ball screw in which screw grooves are meshed with each other via balls, the provision of the spring 9 as described above enables avoiding getting stuck of the screwed portion with certainty.

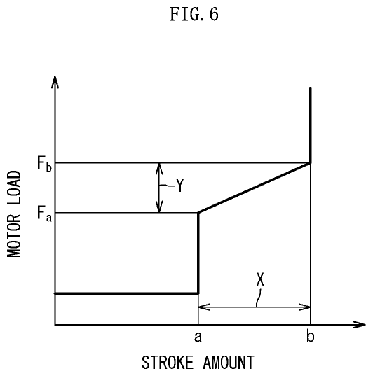

FIG. 6 illustrates the relationship between a stroke amount of the linear motion unit main body 7 and a load applied to the motor 2, when the motor 2 is rotationally driven in the normal direction as described above. As illustrated in the drawing, when the motor 2 is rotationally driven in the normal direction and the output member 8 abuts the operation target P (a stroke amount a), the load applied to the motor 2 rises to Fa. The load Fa at this time depends on the amount of compression of the spring 9 in an initial state where the output member 8 does not abut the operation target P (hereinafter, referred to as an initial compression amount). That is, when the initial compression amount of the spring 9 is reduced, the load Fa applied to the motor 2 when the output member 8 abuts the operation target P can be reduced. On the other hand, when the initial compression amount of the spring 9 is increased, the force of pressing the output member 8 against the operation target P can be increased.

After the output member 8 abuts the operation target P, the load applied to the motor 2 linearly increases, as the stroke amount of the linear motion unit main body 7 (that is, the compression amount of the spring 9) increases. When the screw-shaft-side locking part 12 abuts the nut-side locking part 13 and the rotation of the screw shaft 5 is restricted (a stroke amount b), the load applied to the motor 2 becomes infinite and the motor 2 stops. In this situation, a stroke amount X (=b−a) of the linear motion unit main body 7 from the time when the output member 8 abuts the operation target P to the time when the rotation of the screw shaft 5 stops corresponds to a compression amount from the initial state of the spring 9.

The load applied to the motor 2 is increased to correspond to elastic force Y (=Fb-Fa) caused by the compression of the spring 9.

The present invention is not limited to the above embodiment. Hereinafter, other embodiments of the present invention will be described.

However, overlapped descriptions for similar matters to those in the above embodiment will be omitted.

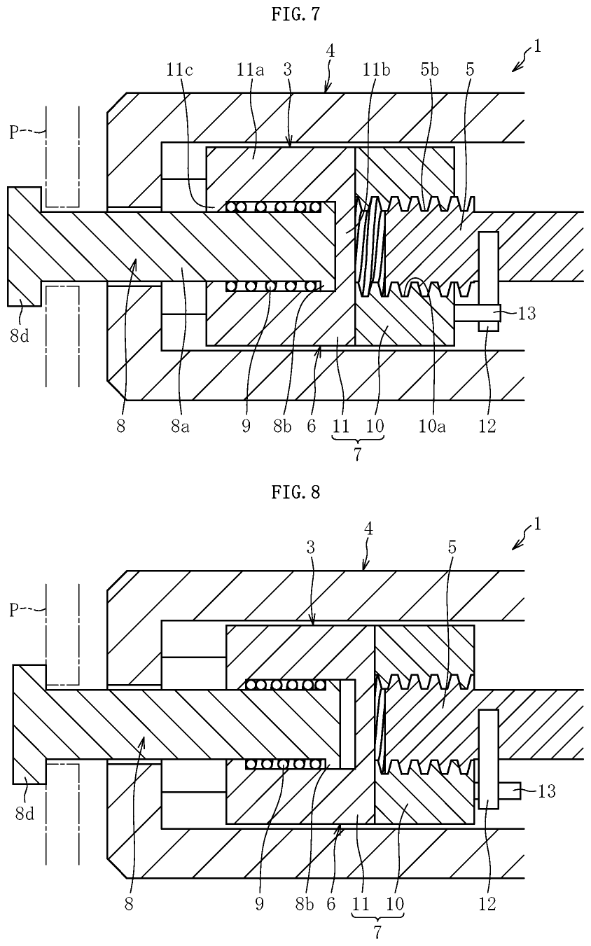

In the embodiment illustrated in FIG. 7, the output member 8 is moved rearward to abut the operation target P. In the illustrated example, the spring 9 is disposed in the compressed state between the flange part 11c of the spring case 11 and the flange part 8b provided at the rear end of the output member 8. When the screw shaft 5 is rotated in the normal direction by the motor 2 from the state illustrated in FIG. 7, the linear motion unit main body 7 and the output member 8 integrally move rearward, and a flange part 8d provided at a front end of the output member 8 abuts the operation target P. Subsequently, when the motor 2 is further rotationally driven, as illustrated in FIG. 8, the linear motion unit main body 7 moves rearward while compressing the spring 9 with the output member 8 abutting the operation target P and remaining stopping at the position. The screw-shaft-side locking part 12 and the nut-side locking part 13 abut each other, so that the rotation of the screw shaft 5 is restricted, and the linear motion unit main body 7 is stopped.

Also in the present embodiment, the output member 8 is pressed against the operation target P while being brought into a floating manner by the spring 9 in the axial direction with respect to the linear motion unit main body 7.

Accordingly, the load applied to the screwed portion of the rotary unit (the screw shaft 5) and the linear motion unit 6 (the nut 10) is reduced, and it is possible to prevent the screwed portion from getting stuck.

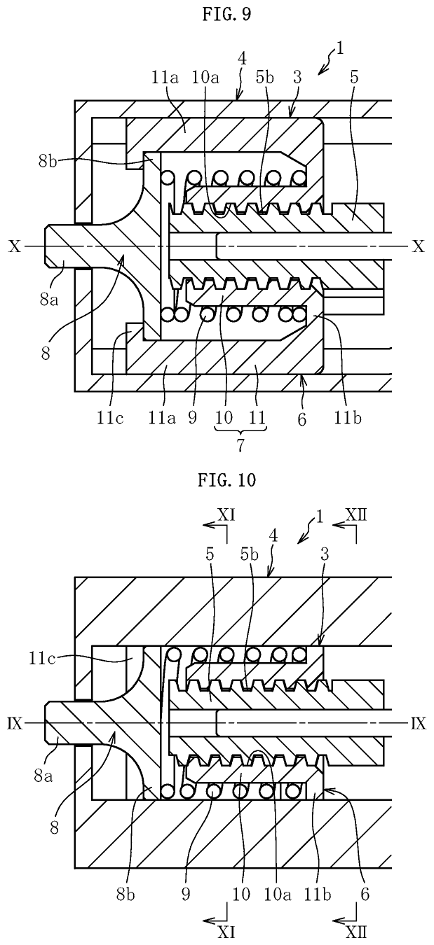

In the linear actuator 1 illustrated in FIGS. 9 and 10, the nut 10 is disposed on an inner periphery of the spring case 11, so as to have a compact size in the axial direction. Specifically, the spring case 11 includes a pair of flat plate-shaped side parts 11a, bottom parts 11b respectively connecting rear ends of the pair of side parts 11a and a rear end of the nut 10, and flange parts 11c extending from front ends of the respective side parts 11a on sides approaching each other (see FIG. 9). In the illustrated example, the spring case 11 and the nut 10 are integrally formed.

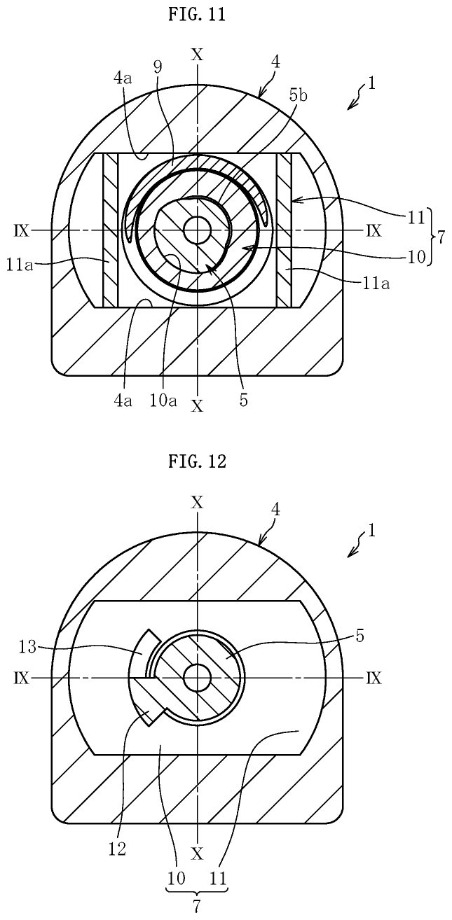

However, the spring case 11 and the nut 10 may be formed separately. The spring 9 is disposed in the compressed state between the bottom parts 11b of the spring case 11 and the flange part 8b of the output member 8. As illustrated in FIG. 11, the side parts 11a of the spring case 11 and the flat surfaces 4a provided on the inner peripheral surface of the housing 4 are engaged with each other in the rotational direction.

Accordingly, the rotation of the linear motion unit main body 7 including the spring case 11 with respect to the housing 4 is restricted. As illustrated in FIG. 12, the screw-shaft-side locking part 12 and the nut-side locking part 13 are engaged with each other in the circumferential direction, so that the rotation of the screw shaft 5 is restricted at a predetermined position.

In the above embodiments, the description has been given with regard to a case where the present invention is applied to a coaxial type of the linear actuator in which the motor 2 and the rotary unit (the screw shaft 5) of the screw mechanism 3 are coaxially disposed.

However, the present invention is not limited to such a case.

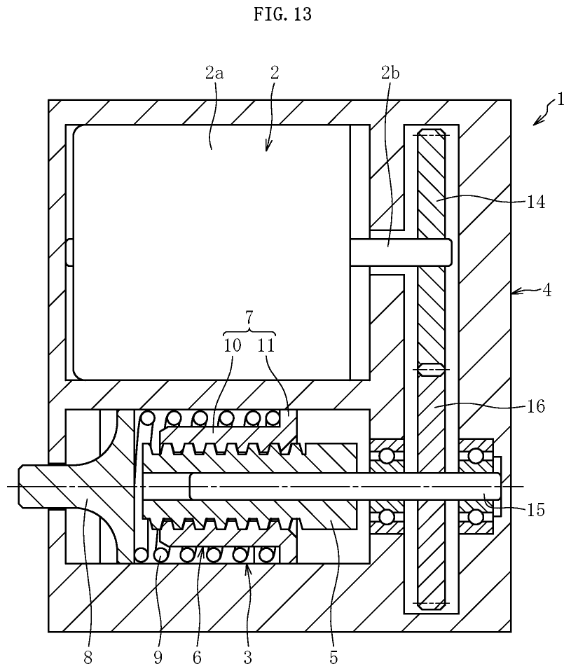

The present invention is also applicable to a parallel axial type of a linear actuator in which a central axis of a motor and a central axis of a rotary unit are disposed to be separated in parallel with each other. For example, in the embodiment illustrated in FIG. 13, the linear actuator 1 illustrated in FIGS. 9 and 10 is modified to the parallel axial type of the linear actuator 1. A gear 14 secured to the rotary shaft 2b of the motor 2 meshes with a gear 16 secured to an intermediate shaft 15 extending from the screw shaft 5, and rotational driving force of the motor 2 is transmitted to the screw shaft 5.

In the above embodiments, the axial rotation type of the linear actuator 1 in which the rotary unit of the screw mechanism 3 includes the screw shaft 5 and the linear motion unit 6 includes the nut 10 has been described.

However, but the present invention is not limited to the above configuration, and is also applicable to a nut rotation type of a linear actuator in which a rotary unit of a screw mechanism includes a nut, and a linear motion unit includes a screw shaft.

### REFERENCE SIGNS LIST

1 Linear actuator
2 Motor
3 Screw mechanism
4 Housing
5 Screw shaft
6 Linear motion unit
7 Linear motion unit main body
8 Output member
9 Spring
10 Nut
11 Spring case
12 Screw-shaft-side locking part
13 Nut-side locking part
P Operation target

1. A linear actuator comprising:
a motor;
a rotary unit to be rotationally driven by the motor; and
a linear motion unit including a screw groove to be screwed with a screw groove provided on the rotary unit, and configured to linearly move in an axial direction in accordance with rotation of the rotary unit, wherein
the linear motion unit includes:
a linear motion unit main body including the screw groove;
an output member provided to be relatively movable in an axial direction with respect to the linear motion unit main body, and configured to abut an operation target; and
a spring disposed between the linear motion unit main body and the output member in the axial direction.

2. The linear actuator according to claim 1, further comprising
a rotation restriction unit configured to restrict the rotation in a normal direction of the rotary unit at a predetermined position, wherein
a gap in a direction of compressing the spring is defined between the linear motion unit main body and the output member, in a state where the rotation restriction unit restricts the rotation in the normal direction of the rotary unit at the predetermined position.

3. The linear actuator according to claim 1, wherein
a screwed portion of the rotary unit and the linear motion unit is a sliding screw in which the screw grooves of both members are directly meshed with each other.

4. The linear actuator according to claim 1, wherein
the spring is disposed beforehand in a compressed state between the linear motion unit main body and the output member in the axial direction.

5. The linear actuator according to claim 1, wherein
the motor includes a rotary shaft having an uneven shape formed on an outer circumferential surface, and
the uneven shape of the rotary shaft bites into an inner peripheral surface of the rotary unit.

6. The linear actuator according to claim 1, wherein
the motor and the rotary unit are coaxially disposed.

7. The linear actuator according to claim 1, wherein
a central axis of the motor and a central axis of the rotary unit are disposed to be separated in parallel with each other.

8. The linear actuator according to claim 1, wherein
the rotary unit includes a screw shaft, and the linear motion unit includes a nut to be screwed with the screw shaft.

9. The linear actuator according to claim 1, wherein
the rotary unit includes a nut, and the linear motion unit includes a screw shaft to be screwed with the nut.
